(19) United States
(12) Patent Application Publication
(10) Pub. No.: US 2016/0292702 A1
(43) Pub. Date: Oct. 6, 2016

(54) Systems and methods for forecasting discounts using crowd source information

(71) Applicant: Intel Corporation, Santa Clara, CA (US)

(72) Inventors: Rajesh Poornachandran, Portland, OR (US); Gyan Prakash, Beaverton, OR (US)

(73) Assignee: Intel Corporation, Santa Clara, CA (US)

(21) Appl. No.: 15/063,374

(22) Filed: Mar. 7, 2016

Related U.S. Application Data
(63) Continuation of application No. 13/711,742, filed on Dec. 12, 2012, now abandoned.

(51) Int. Cl. G06Q 30/02

(52) U.S. Cl. CPC G06Q 30/0202; G06Q 30/0207

(57) ABSTRACT

Systems and methods for forecasting discounts are described herein. In some embodiments, the systems and methods utilize marketplace information to calculate an initial probability that an item will be subject to a discount within a specified time period. The systems and methods may then utilize relevant crowd source information to weight the marketplace information and output a weighted probability of sale.

### CROSS REFERENCE TO RELATED APPLICATION

The present application is a Continuation of U.S. application Ser. No. 13/711,742, filed Dec. 12, 2012, the contents of which are incorporated by reference in entirety.

### FIELD

The present disclosure relates to forecasting systems and methods, including but not limited to systems and methods for forecasting discounts using crowd source information.

### BACKGROUND

Consumers often do not purchase durable goods and/or expensive items impulsively. Rather, they often perform significant research into an item of interest prior to purchasing it. For example, a consumer interested in purchasing an item might consider reviews of the item by other consumers and professional reviewers, the availability of the item at a particular retailer or online store, and other information that can help the consumer determine whether or not the item is desirable.

Among other factors, price often has a significant impact on whether a consumer is interested in purchasing an item. Indeed, consumers may ignore an item that is outside of their budget, or hope that the item will go on sale so that they can purchase it at a desirable price. A consumer might also engage in “buy and return” behavior, in which they purchase an item at a first (e.g., full) price only to return it if they later learn that the item is offered at a lower second price at the same or different retailer. Buy and return behavior is common around major holiday sales, when retailers often offer significant discounts on items after the holiday has past. While such behavior is understandable, it can waste consumer time and can negatively impact retailer cash flow.

In any case, consumers often try to purchase items in a manner that is consistent with their budget and goals. When a consumer is seeking to purchase a gift for example, he or she may try to locate and purchase a suitable item at a desirable price within a particular time frame, e.g., on or before a holiday, birthday, or another date. To that end, many systems have been developed to assist consumers to identify current sales/offers/coupons/discounts on an item of interest. For example, websites exist that collect advertisements, coupons, and other offers from retailers, and make such information available to the public. Consumers may access this information through the website and thus learn of current offers that may pertain to an item of interest. Consumers may of course also consult more traditional sources to identify current offers pertaining to an item of interest, such as print, radio, and television advertising.

Although existing systems can assist consumers to identify current discounts on items, they generally do not help consumers identify whether or if a product is likely to be offered at a lower price at some future time. Consumers therefore often have difficulty identifying the best time to buy an item. This is particularly true with respect to items that are updated frequently (e.g., cellular phones, televisions, other electronics), which have a relatively short shelf life (e.g., food, seasonal items, etc.), and/or which are time dependant (e.g., services such as airline travel, hotel travel, equipment rentals, etc).

### BRIEF DESCRIPTION OF THE DRAWINGS

Features and advantages of embodiments of the claimed subject matter will become apparent from the following detailed description and the drawings, wherein like numerals depict like parts, and in which:

FIG. 1 is a block diagram illustrating an overview of an exemplary system consistent with the present disclosure;

FIG. 2 is a block diagram of an exemplary forecasting device consistent with the present disclosure;

FIG. 3A is a block diagram illustrating an overview of another exemplary system consistent with the present disclosure;

FIG. 3B is block diagram providing further details of the system shown in FIG. 3A; and

FIG. 4 is a flowchart of an exemplary method consistent with the present disclosure.

Although the following detailed description will proceed with reference being made to illustrative embodiments, many alternatives, modifications, and variations thereof will be apparent to those skilled in the art.

### DETAILED DESCRIPTION

The present disclosure relates to systems and methods for forecasting discounts. As discussed below, the systems and methods of the present disclosure can provide a convenient and powerful tool to aid consumers in identifying an advantageous time to purchase an item of interest. For example, the systems and methods of the present disclosure may provide consumers with information regarding the probability that an item of interest will be subject to a discount within a specified time period. In some embodiments, the systems and methods of the present disclosure may forecast the probability of a discount on an item from marketplace information, crowd source information, and combinations thereof.

The term “mobile device” is used herein to mean any of a wide variety of portable electronic devices, including but not limited to cell phones, electronic readers, handheld game consoles, mobile internet devices, portable media players, personal digital assistants, smart phones, ultra-mobile PCs, netbooks and notebook computers. As described below, mobile devices may be used to initiate and/or perform one or more discount forecasting operations.

The phrase, “other electronic devices” is used herein to broadly refer to the wide swath of electronic devices that may be used to initiate and/or perform one or more discount forecasting operations, but which may not fall into the narrower (but still broad) purview of a mobile device. Non-limiting examples of other electronic devices include automated teller machines (ATM's), desktop computers, wired telephones, kiosks, network (e.g., cloud) servers, enterprise terminals, and public computer terminals.

The terms “discount,” “offer,” and “sale” are used interchangeably herein to refer to a deal involving an item of interest. Discounts, offers, and sales include but are not limited to a reduced price on an item of interest, a coupon on an item of interest, an offer including the item of interest (e.g., a combination offer such as buy one get one free, buy item A get item B, etc.), combinations thereof, and the like.

The terms “forecast,” and “forecasting,” are interchangeably used herein to mean the prediction of the probability of a discount on an item of interest over a specified time period. For the sake of clarity, the probability that an item will be subject to a discount is hereinafter referred to as “probability of discount.”

The term “marketplace information” is used herein to refer to data, factors, and other information relevant to the price history of an item that is the subject of a forecasting request. Non-limiting examples of marketplace information include data and information regarding product advertising, branding, the buyer decision process, customer satisfaction, demand, demographics, discount history, distribution, environmental considerations (e.g., the existence of natural disasters affecting supply or demand), product positioning, price elasticity, price history (general or reseller specific), supply, social network potential, “trendiness,” transportation/shipping costs, combinations thereof, and the like, as they relate to a particular item. Generally, marketplace information is information that is generated prior to receipt of a forecasting request by the systems and methods described herein.

It should be understood that marketplace information is aggregated or otherwise collected/received by the systems and methods of the present disclosure from sources other than a consumer or potential consumer of the item of interest. Thus, while marketplace information may or may not be generated from consumers, the systems and methods of the present disclosure obtain marketplace information from sources other than consumers. Non-limiting examples of such sources include public sources such as advertising, reseller websites, the internet, and the like, and private sources such as market research firms, market research databases, and the like. In some embodiments, marketplace information is or includes “secondary information,” i.e., information that has been previously collected by a third party.

The term “crowd source information” is also used herein to refer to data, factors, and other information relevant to the price of an item that is subject to a forecast request. In contradistinction to marketplace information, crowd source information is information that is collected or otherwise received by the systems and methods of the present disclosure directly from a consumer or potential consumer of the item. Crowd source information may therefore include consumer and/or prospective consumer input regarding one or more of the same factors specified above for marketplace information. For example, crowd source information may include a consumer's perception of the demand for the item, its trendiness, advertising, price, etc., combinations thereof, and the like. Such information may be based on the consumer's actual experiences shopping for, researching, and/or attempting to purchase the item in question.

Crowd source information can be more specific and/or recent in time than marketplace information. Indeed, crowd source information may include information that is specific to a particular seller, store, event, time, combinations thereof, and the like. Crowd source information may therefore include the observations of a consumer and/or potential consumer regarding item inventory, price, demand, offers, in-store coupons, etc., combinations thereof, and the like at a particular seller, store, event, and/or time. More generally, crowd source information may include seller, store, event, and/or time specific information that is relevant to the price of an item of interest, but which may be lost or unreported in marketplace information.

As used in any embodiment herein, the term “module” refers to software, firmware and/or circuitry configured to perform any of the aforementioned operations. Software may be embodied as a software package, code, instructions, instruction sets and/or data recorded on non-transitory computer readable storage mediums. Firmware may be embodied as code, instructions or instruction sets and/or data that are hard-coded (e.g., nonvolatile) in memory devices. “Circuitry”, as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry. Modules described herein may, collectively or individually, be embodied as circuitry that forms part of a larger system, for example, an integrated circuit (IC), system on-chip (SoC), application specific integrated circuit (ASIC), a desktop computer, laptop computer, tablet computer, server, smart phone, etc. and combinations thereof.

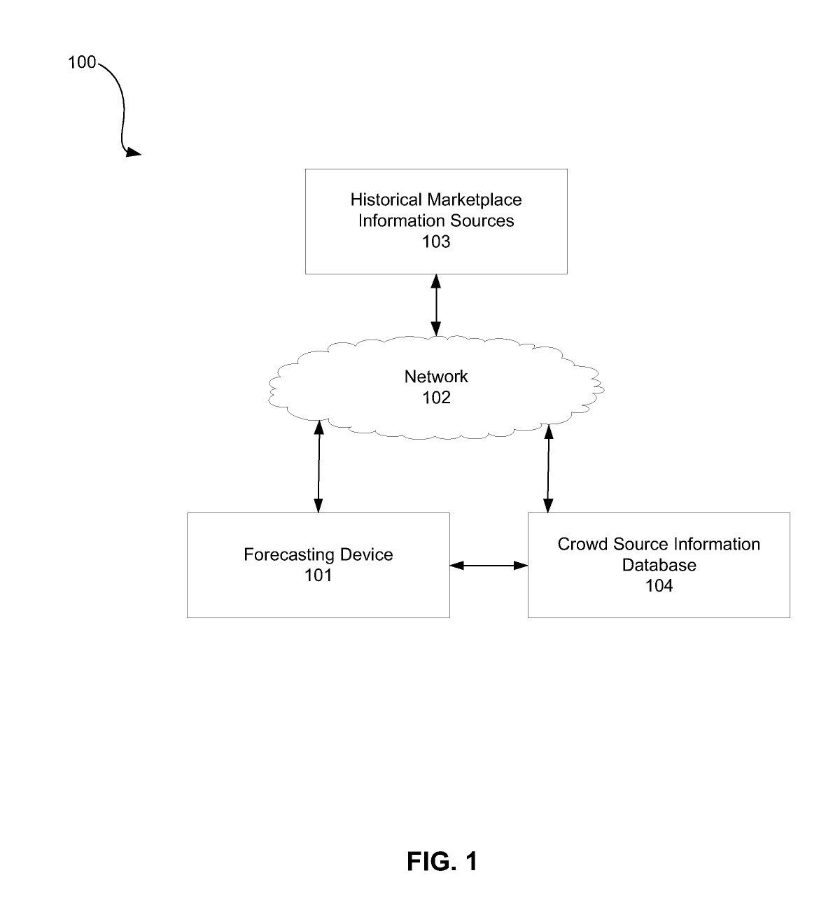

Reference is now made to FIG. 1, which illustrates an overview of an exemplary system for forecasting discounts consistent with the present disclosure. System 100 generally includes forecasting device 101, network 102, marketplace information source 103, and crowd source information database 104. For clarity, system 100 has been illustrated as including a single forecasting device, network, marketplace information source, and crowd source information database. Such illustration is exemplary only, and it should be understood that any number of such components may be included in the systems and methods described herein.

Forecasting device 101 may be in the form of one or more mobile or other electronic devices, as defined above. In some embodiments, forecasting device 101 is a mobile device chosen from cell phones, mobile internet devices, personal digital assistants, smart phones, ultra-mobile PCs, netbooks, notebook computers, and combinations thereof. Forecasting device 101 may alternatively or additionally be in the form of one or more network (e.g., internet/cloud) servers, desktop computers, and combinations thereof. Without limitation, forecasting device 101 is preferably one or more network servers.

Forecasting device 101 may communicate with marketplace information source 103 and crowd source information database 104. Such communication may be bi-directional, and may occur through a direct data connection (not shown), through network 102, or a combination thereof. Forecasting device 101 may similarly communicate with crowd source information data base 104, e.g., through a direct data connection, network 102, or a combination thereof.

Network 102 may be any network that carries data. Non-limiting examples of suitable networks that may be used as network 102 include the internet, private networks, virtual private networks (VPN), public switch telephone networks (PSTN), integrated services digital networks (ISDN), digital subscriber link networks (DSL), wireless data networks (e.g., cellular phone networks), other networks capable of carrying data, and combinations thereof. In some embodiments, network 102 is chosen from the internet, at least one wireless network, at least one cellular telephone network, and combinations thereof. Without limitation, network 102 is preferably the internet.

Marketplace information source 103 may be any source of marketplace information. Suitable marketplace information sources include but are not limited to public and private websites, government research databases, market research databases, electronic storefronts, inventory management systems, print, audio, and electronic advertising, weather centers, news and other media outlets, economic reports, analyst projections, product recalls, demographic information, combinations thereof, and the like. In some embodiments, marketplace information source 103 may be stored on one or more mobile or other electronic devices that may interface with forecasting device 101. For example, marketplace information source 103 may be stored in and/or executed on one or more servers which may be co-located and/or distributed geographically.

Forecasting device 101 may aggregate or otherwise collect marketplace information regarding items of interest to a consumer, as described further below. In some embodiments, forecasting device 101 may store aggregated marketplace information in memory (not shown). Such memory may be local to forecasting device 101, remote to forecasting device 101, or a combination thereof. Thus, while FIG. 1 depicts marketplace information source 103 a being separate from forecasting device 101, it should be understood that forecasting device 101 may develop, store, and maintain its own collection/database of marketplace information. Forecasting device 101 may be able to access such “internal” sources of marketplace information more easily and/or rapidly than it can access external sources of marketplace information.

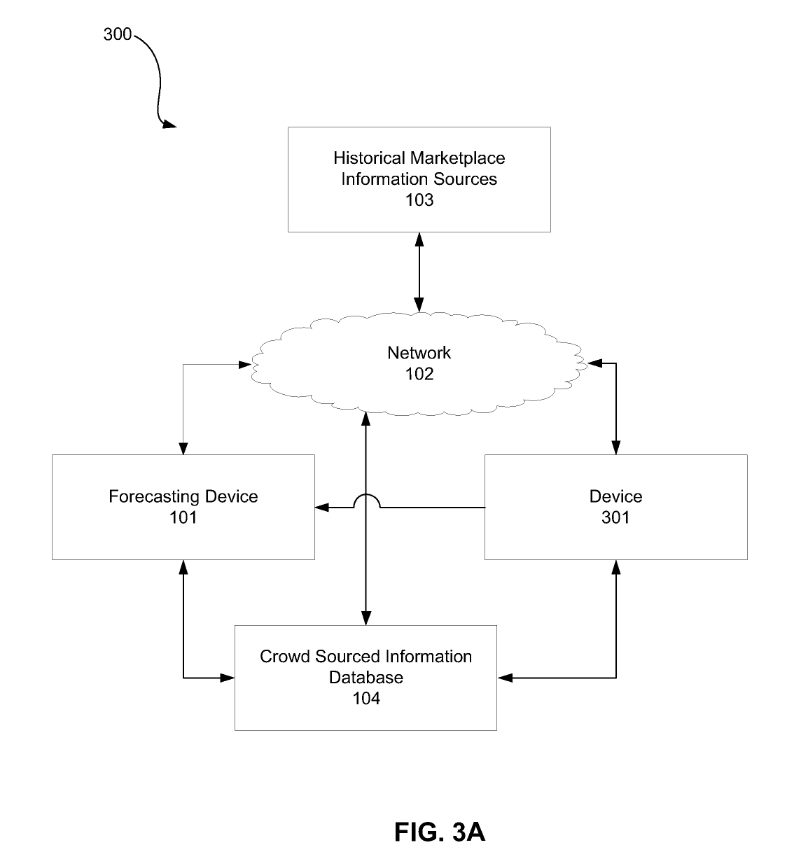

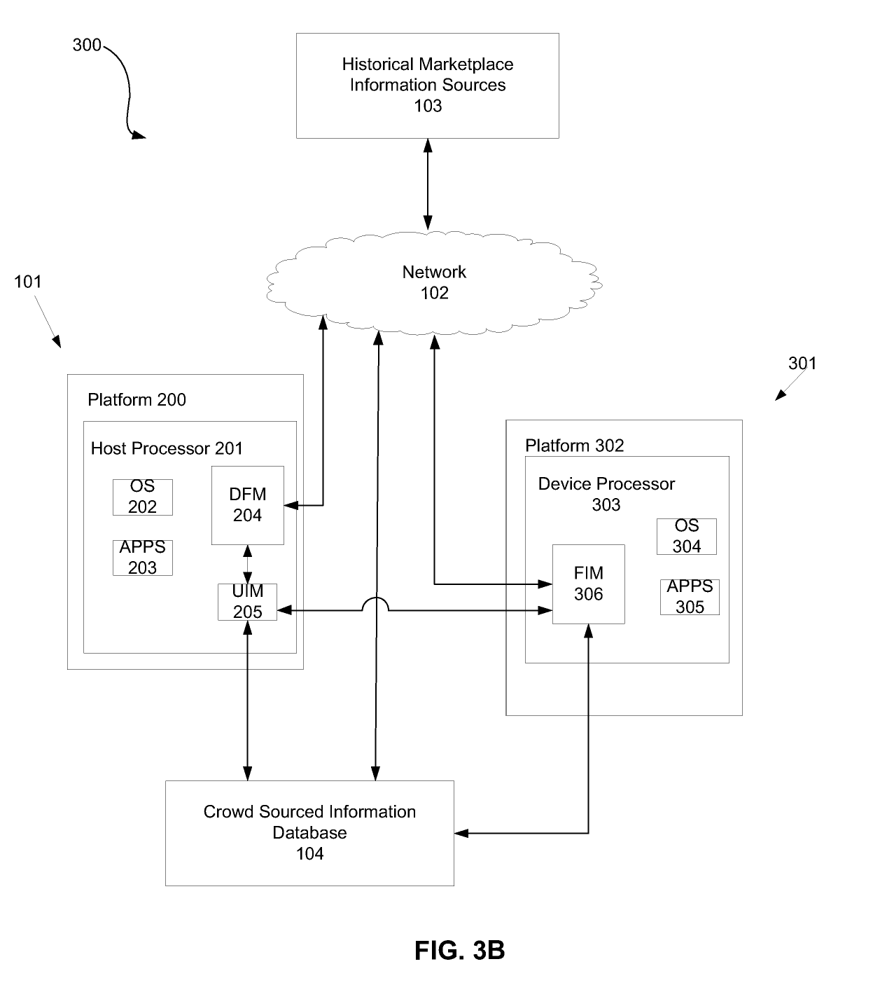

Crowd source information database 104 may be any database capable of storing crowd source information. Such database may be stored and/or executed on one or more mobile or other electronic devices that may interface with forecasting device 101. Thus, like marketplace information source 103, crowd source information database 104 may be stored and/or executed on one or more co-located and/or geographically distributed servers. Alternatively or additionally, crowd source information database may be stored in memory within and/or accessible to forecasting device 101 (not shown). In some embodiments, crowd source information may be input into crowd source information database 104 by one or more consumers and/or potential consumers. Such inputs may be made through forecasting device 101 or another mobile or other electronic device, as described later in connection with FIGS. 3A and 3B.

In operation, forecasting device 101 may receive a forecast request, e.g., from one or more mobile or other electronic devices (not shown). The forecast request may include information about an item (or items) that a potential consumer is interested in, as well as instructions that prompt forecasting device to perform one or more forecasting operations consistent with the present disclosure. More specifically, the forecast request may prompt forecasting device 101 to execute one or more forecasting operations and output a probability of discount relevant to the item(s) that is (are) the subject of the forecast request.

Information about the item may include for example the name, make, model, serial number, universal product code, quick-response (QR) code, and color of the item, other information (e.g., a description of the item and/or one or more features thereof), and combinations thereof. The forecast request may also contain other information that may be useful in the determination of a probability of discount by forecasting device 101. Without limitation, such other information may include the number of items sought, the geographic region in which the item is to be purchased, a desired purchase price for the item, a time frame in which the item is to be purchased, combinations thereof, and the like. The forecasting request may also include certain scope factors that forecasting device 101 may take into account when determining a probability of discount. For example, the forecasting request may specify a particular retailer, a particular location (e.g., store and/or event), geographic regions, combinations thereof, and the like.

In response to receiving a forecast request, forecasting device 101 may aggregate marketplace information that is pertinent to the request. Non-limiting examples of marketplace information relevant to a forecasting request include the price-history of the item in question, available supply of the item, market demand for the item, the availability of competitive products, manufacturer forecasts for revenue targets, inventory, demand, etc. with regard to the item of interest, combinations thereof, and the like. Pertinent marketplace information may also include information about secondary factors that may impact the price of the item of interest. Examples of such secondary factors include technology and/or fashion trends, market trends, economic factors, consumer spending data, regional trends, seasonal trends, local laws (e.g., tax laws), environmental considerations (e.g., weather and/or natural disasters that may affect manufacturing and/or supply), combinations thereof, and the like.

Forecasting device 101 may communicate with marketplace information source 103 (and/or sources of such information internal to forecasting device 101) and retrieve marketplace information pertinent to the forecast request. Such communications may occur between respective communications circuitry (not shown) within forecasting device 101 and marketplace information source 103. In some embodiments, such communications occurs using one or more communications protocols, such as but not limited to transmission control protocol and internet protocol (TCP-IP), file transfer protocol (FTP), a wireless network protocol, another protocol, or the like. In any case, marketplace information relevant to the forecast request may be transferred from marketplace information source 103 to forecasting device 101.

While the present disclosure envisions systems and methods wherein forecasting device 101 collects marketplace information by communicating with marketplace information sources and effecting a file transfer, such a mechanism is not required. Indeed, forecasting device 101 may employ one or more web search programs, bots, crawlers, and the like to search network 102 and resources connected thereto (including marketplace information source 103) for marketplace information. For example, forecasting device 101 may analyze current and past websites of appropriate retailers to obtain marketplace information relevant to a forecast request.

Forecasting device 101 may utilize information in a forecasting request to streamline its aggregation of marketplace information. Indeed, in response to a forecast request specifying that an item is sought for purchase within a specified (second) time frame (e.g. between two future dates), forecasting device 101 may gather marketplace information generated during a first time frame that is relevant to said second time frame (e.g., between the two dates specified in the forecast request, but in one or more prior years). For example, if a forecast request specifies that a consumer wishes to purchase a specific item between Aug. 1 and Sep. 1, 2012 (first time frame), forecasting device 101 may limit its collection of marketplace information to information generated during (or which it otherwise relevant to) offers on that between August 1 and September 1 of one or more prior years, e.g., 2011, 2010, 2009, etc.

Forecasting device 101 may also streamline its aggregation of marketplace information by taking into account other factors specified in a forecast request. Indeed, in response to a forecast request specifying a particular retailer, store, event, geographic region, etc., forecasting device 101 may limit its aggregation of marketplace information to such retailer, store, geographic region, etc. Forecasting device 101 may therefore accelerate and/or improve the efficiency of its aggregation of marketplace information, and may tailor its probability of discount determination to factors specified in the forecast request.

Once forecasting device 101 aggregates marketplace information relevant to a forecast request, it may calculate an initial probability of discount on item over a second (e.g., future) time frame based on such marketplace information. In some embodiments, forecasting device 101 may calculate an initial probability of discount by dividing/sorting marketplace information into one or more factors. Forecasting device 101 may assign a weight to and determine a score for each factor based on a correlation of each factor to discounts on the item offered a first time frame (e.g., past dates correlating to the first time frame), with a weight corresponding to the maximum score that may be assigned to a respective factor. Forecasting device 101 may then calculate an initial probability of discount using the assigned weights and determined scores, e.g., using formula 1 below:

P_{I}=(ΣHₙ)/(ΣWₙ)*100% (1)

wherein P_{I} is the initial probability of discount (e.g., in percent) on an item over the specified (second) time period, ΣHₙ is the sum of the scores determined by forecasting device 101 for each element of marketplace information (H) collected over a relevant first time period, ΣWₙ is the sum of the corresponding weights assigned to each element of marketplace information by forecasting device 101, and n is representative of the marketplace information factor under consideration.

As an illustrative example, consider a scenario in which forecasting device 101 receives a forecast request pertaining to a specific television. The request specifies that a consumer is interested in purchasing the television in a specified (second) time frame, and at a particular retailer. In response, forecasting device 101 aggregates relevant marketplace information. For simplicity, this example will proceed under the assumption that marketplace information gathered by forecasting device 101 is limited to historical pricing of the television at the specified retailer over the relevant time period in past years (first time frame), the retailer's inventory of the television (current and/or over a specific time period), and retailer's advertisements relevant to the first and second time frames.

Forecasting device 101 may be configured to assign a weight W to each marketplace information factor. Weight W may for example be a point scale which may range from a minimum to a maximum value (e.g., 0 to 100 points). In some embodiments, forecasting system may be configured to assign the same weight scale to each factor of marketplace information by default. In other words, forecasting device 101 may initially assign the same weight (W) to each marketplace information factor utilized in the above algorithm. Alternatively or additionally, forecasting device 101 may be configured to weight certain marketplace information factors more heavily than others. Heavier weighting may be achieved by assigning a larger point scale to a particular factor (e.g., 0 to 200 points, vs. 0 to 100 points).

In some embodiments, forecasting device 101 may more heavily weight marketplace information factors that are expected or determined to have a larger correlation with prior discounts on the item of interest. Accordingly weights and/or scores for such factors may be predetermined and input to forecasting device, or may be determined by forecasting device 101 through the application of market analytics and/or economic analysis to the marketplace information data. In the latter case, application of market analytics and/or economic analysis may reveal to forecasting device 101 that certain marketplace information factors exhibit a relatively strong correlation with past discounts (e.g., reduced prices or other offers) on the item during a first (past) time frame, whereas others may exhibit a relatively weak correlation. In such instances, factors showing a strong correlation with discounts in a second (future) time frame may be weighted more heavily by forecasting device 101 than factors showing a relatively weak correlation.

For clarity, explanation of the illustrative example will now proceed under the assumption that forecasting device 101 assigns the same weight, namely 100 points, to each factor of the marketplace information collected in response to the forecasting request. In other words, forecasting system assigns a weight of 100 points to the collected historical pricing of the television at the specified retailer over time, the retailer's inventory of the television over time, and the retailer's past and current advertisements.

Forecasting device 101 may also be configured to determine a score (H) to each factor of marketplace information it collected in response to the forecast request. Like the aforementioned weights, forecasting device 101 may determine score by performing market analytics and/or economic analyses on the collected marketplace information data. Factors showing a strong and/or repeated correlation with a past discount on an item (e.g., a reduced price, a combination offer, a coupon, etc.) may be scored higher by forecasting device 101 than factors showing a weak and/or isolated correlation with a past discount on the item.

Turning back to the illustrative example, the following explanation will proceed with the assumption that forecasting device 101 determines that: 1) the specified retailer has offered a discounted price on the television of interest during the specified time period in each of the prior three years; 2) that the number of televisions in the retailer's inventory over the relevant time period in the past three years shows a small correlation with the discounted price of the television during that time period; and 3) the retailer's advertisements governing the second (future) time frame specified in the forecast request indicate that the retailer will offer a sale on electronics during that time period, but does not specifically indicate that the television in question will be on sale. Based on this information, forecasting device 101 may assign a score (H) of 100 points to the historical pricing factor, 25 points to the inventory factor, and 75 points to the advertising factor.

After assigning a weight (W) and determining a score (H) for each marketplace information factor collected, forecasting device 101 may calculate an initial probability of discount (P_{I}) using formula 1 above. In this case, P_{I}=(100+25+75)/(100+100+100)*100, or 66%. In other words, the initial probability of discount calculated by forecasting device 101 indicates that there is a 66% chance that the television will be on sale during the time period specified in the forecasting request.

Simultaneously with or subsequent to determining the initial probability of discount, forecasting device 101 may aggregate crowd source information relevant to the forecast request. In this regard, forecasting device 101 may communicate with crowd source information data base 104 (and/or sources of such information internal to forecasting device 101) and retrieve pertinent CSI* information. Similar to its communication with marketplace information source 103, forecasting device 101 communicate with crowd source information database 104 using one or more communications protocols, such as transmission control protocol and internet protocol (TCP-IP), file transfer protocol (FTP), another protocol, or the like. In instances where crowd source information is stored on memory that is integral or accessible to forecasting device 101, forecasting device 101 may retrieve such information by way of a read request issued to an appropriate memory controller.

Similar to marketplace information factors, forecasting device 101 may assign a weight (C_{H}) to crowd source information factors. A weight (C_{H}) may be assigned by forecasting device 101 to a particular crowd source information factor based on the degree to which that factor enhances or detracts from existence of a discount on the item of interest during a first (past) time frame or a second (future) time frame. For example, forecasting device 101 may increase the weight assigned to crowd source information factors confirming the existence of one or more discounts on the item of interest in a relevant time frame), and decrease the weight assigned to crowd source information factors suggesting the non-existence of such discounts. In sum, forecasting device may assign a weight (C_{H}) to each respective crowd source information factor that reflects the correlation of such factor to the existence or non-existence of a discount on an item during a past (first) time frame and/or a second (future) time frame.

In some instances, crowd source information collected by forecasting device 101 may correlate to the marketplace information factors utilized in the calculation of the initial probability of discount. In such instances, forecasting device 101 may apply the weights assigned to relevant crowd source information factors to adjust the score and/or weight assigned to the marketplace information factors specified above (e.g., on scores H and/or weights W in formula 1). Forecasting device 101 may then calculate a weighted probability of discount (P_{R}) using formula 2 below:

P_{R}=(Σ(Hₙ*C_{Hn})/Σ(Wₙ))*100 (2)

Where P_{R} is the weighted probability of discount (e.g., in percent), Hₙ and Wₙ are as previously defined, and C_{Hn} is the weight assigned by forecasting device 101 to each crowd source information factor relevant to a corresponding marketplace information factor (Hₙ).

Simultaneously with or subsequent to calculating P_{I}, forecasting device 101 may retrieve crowd source information pertaining one or more marketplace information factors used in the calculation of P_{I}. As explained above, such crowd source information factors may reflect actual consumer and/or potential consumer experiences relating to the purchase of the television in question during a relevant past time frame. For the sake of clarity, the following discussion will proceed under the assumption that crowd source information data collected by forecasting device 101 reflects that prior consumers reported that in the past three years, the television under consideration was always on sale when the retailer issued an advertisement similar to the one retrieved as marketplace information, and that no crowd source information relevant to historical pricing and inventory of the television was available.

Based upon this information, forecasting device 101 may adjust the H variables (marketplace information scores) in formula 2 by determining appropriate weight values (C_{H}) for the crowd source information factors and applying such weights to the relevant H variable. In this regard, it may be understood that forecasting device 101 may be configured to assign an initial default value to the C_{H} variables. Such default value may be any value, so long as it is initially applied to each C_{H} variable in formula 2. Alternatively or additionally, the default values for each C_{H} variable may differ, and may be initially set to reflect a predetermined weighting scheme.

In any event, forecasting device 101 may adjust the value of a respective C_{H} variable to reflect the correlation of its corresponding crowd source information factor to the existence or non-existence of a discount on an item of interest. In this regard, forecasting system may be configured to analyze the aggregated crowd source information, e.g., using market analytics and/or economic analyses. Based on the outcome of such analyses, forecasting device 101 may adjust the default value of a C_{H} variable appropriately. That is, forecasting device 101 may adjust the default value of a C_{H} variable to account for the increased or decreased correlation (as indicated by crowd source information) between the corresponding Hₙ variable and a discount on the item in question.

Returning to the illustrative example, forecasting device 101 may initially apply a default value (e.g., 1) to each C_{H} variable corresponding to historical marketing information factors considered in formula 2. As noted previously, crowd source information in this example suggests that in the past three years, consumers have always seen the television in question on sale at the retailers establishment when the retailer issued an advertisement similar to the one retrieved by forecasting device 101 as HMI. This suggests that historical advertising has a high correlation to historical discounts on the television. Forecasting device 101 may take this trend into account by increasing the C_{H} value corresponding to advertising above its default value of 1 (e.g., about 1.1, 1.2, 1.3, 1.4, 1.5 etc.). As a result, the value of (Hₙ*C_{Hn}) for the advertising variable will increase, reflecting the increased relevance of historical advertisements on the probability that the television under consideration will be on sale when similar advertisements are issued. In this example, forecasting device 101 may not adjust the default C_{H} values related to historical pricing and inventory, because crowd source information relevant to such parameters was unavailable. Of course, if crowd source information suggested that a particular H factor had less correlation to a historical discount, forecasting device 101 could account for this by reducing the corresponding C_{H} variable from its default value by an appropriate amount.

Applying the above to formula 2 using the previously specified H and W factors, forecasting device 101 may calculate a weighted probability of discount P_{R} for the television as follows:

P_{R}=((100*1)+(25*1)+(75*C_{H3})/300))*100

Accordingly, if forecasting device 101 assigns a value of 1.5 to C_{H3}, P_{R} will equal 79.1%. Thus, P_{R} in this example was about 13% higher than P_{I}, reflecting the increased weight applied to advertising in the calculation of the weighted probability of discount.

As explained previously, forecasting device 101 may use crowd source information to weight the scores assigned to corresponding marketplace information in the calculation of P_{I} and P_{R}. While such operations may enhance the accuracy and/or reliability of the calculated probability of discount (specifically P_{R}), they do not account for crowd source information that does not correspond to marketplace information, but which may nonetheless have an impact on the probability that an item will be subject to a discount at a specified time frame. Non-limiting examples of such crowd source information include information reported by consumers and potential consumers about unadvertised, impromptu, and/or ad-hoc offers involving an item of interest. Such offers may include unadvertised deals on the item of interest, e.g., an open box/return item deal, a price reduction based on the time of day (frequently used with products having limited shelf life such as food), a time limited combination offer, combinations thereof, and the like. Similarly, crowd source information may report the presence of a manufacture/vendor kiosk in a retailer, as well as discounts (e.g., promotional coupons) offered through the kiosk.

As may be appreciated, such factors may not be captured and/or reported in marketplace information. Nonetheless, they may have an impact on the price of an item, and may provide insight into the likelihood that a particular item is likely to go on sale. Indeed when aggregated over time, crowd source information related to such factors may show trends and/or patterns that indicate when a retailer is likely to offer such unadvertised, impromptu, and/or ad-hoc deals.

Forecasting device 101 may therefore be configured to leverage crowd source information regarding unadvertised, impromptu, and/or ad-hoc offers to enhance the calculation of revised probability of discount (P_{R}). In this regard, forecasting device 101 may analyze crowd source information pertaining to such offers and assign an appropriate score and weight. Forecasting device 101 may then use the assigned score and weight in much the same fashion as it uses marketplace information. Specifically, forecasting device may use such information to calculate a revised probability of discount using equation 3 below:

P_{R}=(Σ((Hₙ*C_{Hn})+(Uₙ))/Σ((W_{Hn})+(W_{Un})))*100% (3)

where P_{R}, Hₙ, and C_{Hn} are as previously defined, (Uₙ) is a score determined by forecasting device 101 for each element of crowd source information relating to an unadvertised, impromptu, and/or ad-hoc offer on an item, and W_{Un} is a weight (e.g., reflecting a maximum score) assigned by said forecasting device to each element of crowd source information relating to an unadvertised, impromptu, and/or ad-hoc offer on an item. The score (Uₙ) and weight (W_{Un}) of each crowd source information factor pertaining to an unadvertised, impromptu, and/or ad-hoc offer may be determined by forecasting device 101 in the same manner as the scoring and weighting of Hₙ and W_{Hn} previously described, and thus is not described in detail herein.

By taking into account crowd source information related to unadvertised, impromptu, and/or ad-hoc offers on an item, the accuracy and reliability of the probability of discount produced by the systems and methods may be further enhanced. Indeed, use of such factors in the calculation of P_{R} may allow the system and methods described herein to inform consumers of probable discounts that may otherwise have been overlooked by forecasts based on marketplace information alone. Such information may also allow the systems and methods to calculate probabilities of discounts using information that is highly granular in time. For example, such information may pertain to discounts and other offers that are available over the course of relatively short time periods, e.g., a minute, an hour, a day, several days, and/or a week.

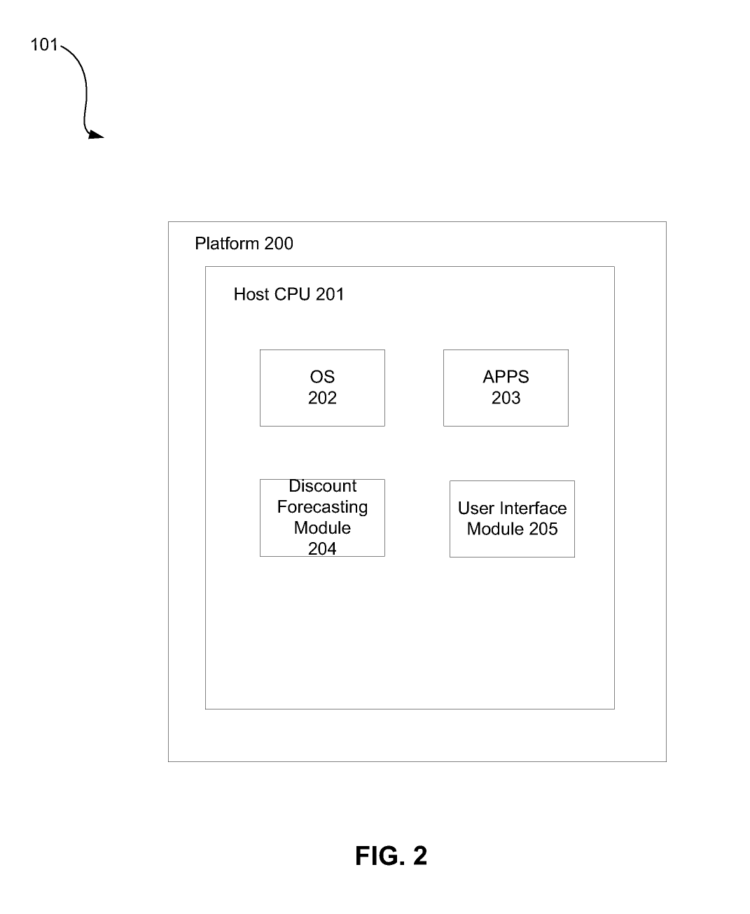

FIG. 2 is a block diagram illustrating an exemplary architecture of a forecasting device consistent with the present disclosure. As shown, forecasting device 101 includes at least one device platform 200. Without limitation device platform 200 may be an appropriate platform for a mobile or other electronic device, as defined above. Accordingly, device platform may be chosen from a cell phone platform, an electronic reader platform, an enterprise server platform, a handheld game console platform, a mobile internet device platform, a portable media player platform, a personal digital assistant platform, a smart phone platform, an ultra-mobile PC platform, a netbook platform, a network server platform, a notebook computer platform, and combinations thereof. In some non-limiting embodiments, device platform 200 is a network or enterprise server platform.

Device platform 200 includes at least one host processor 201 (hereafter, processor 201), which may be configured to execute software such as but not limited to operating system (OS) 202, applications (APPS) 203. Device platform 200 may further include discount forecasting module (DFM) 204, which may be configured to perform one or more discount forecasting operations consistent with the present disclosure. Device platform 200 may also include user interface module 205, which may be configured to receive crowd source information, user feedback and the like, and relay such information to an appropriate location.

In some embodiments, DFM 204 and UIM 205 may be in the form of instructions stored on a memory (not shown) that is integral to or otherwise accessible by processor 201. Such memory may include one or more of the following types of memory: semiconductor firmware memory, programmable memory, non-volatile memory, read only memory, electrically programmable memory, random access memory, flash memory (which may include, for example, NAND or NOR type memory structures), magnetic disk memory, and/or optical disk memory. Additionally or alternatively, such memory may include other and/or later-developed types of computer-readable memory.

Device platform 200 may further include chipset circuitry (not shown). Such chipset circuitry may include integrated circuit chips, such as those selected from integrated circuit chipsets commercially available from the assignee of the subject application, although other integrated circuit chips may also or alternatively be used.

Reference is now made to FIG. 3A, which is a block diagram of another forecasting system in accordance with the present disclosure. As shown, system 300 includes many of the same components as system 100 shown in FIG. 1. For example, system 300 includes forecasting device 101, network 102, historical information source 103, and crowd source information database 104. These components have been previously described in connection with FIG. 1, and so are not described again here.

In addition to the foregoing components, system 300 includes device 301. Device 301 may be a mobile or other electronic device, as defined above. Without limitation, device 301 is preferably a mobile device, such as a cell phone, an electronic reader, a handheld game console, a mobile internet device, a portable media player, a personal digital assistant, a smart phone, an ultra-mobile PC, a netbook, a network server, a notebook computer platform, and combinations thereof.

Device 301 may initiate one or more forecasting operations consistent with the present disclosure by sending a forecasting request to forecasting device 101. Device 301 may communicate such forecasting request directly to forecasting device 301, e.g., via a direct wire connection, one or more wireless communications protocols (e.g., BLUETOOTH™, near field communication, a ZigBee network, and the like), and combinations thereof. Alternatively or additionally, Device 301 may communicate with forecasting device 101 through network 102. As will be described later, device 301 may generate and send a forecasting request in response to an input from a user, e.g., through a forecast initiation module executed on device 301. In any case, forecasting device 101 may be prompted to perform one or more forecasting operations in response to receiving a forecasting request, as explained above.

Device 301 may also be configured to gather crowd source information from one or more consumers, such as a user of device 301. Thus for example, device 301 may be configured to accept inputs from consumers relating to items that they are interested in/or have purchased. Such inputs may be crowd source information and defined and discussed above. Thus for example, a consumer may input information he or she has regarding an item of interest into device 301. Device 301 may then communicate such information to crowd source information database 104. Accordingly, device 301 may be in wired or wireless communication with crowd source database 104. Such communication may occur through a direct connection between device 301 crowd source information database 104, or through network 102. In any case, it may be understood that device 301 is capable of conveying crowd source information to crowd source information database 104.

Reference is now made to FIG. 3B, which provides further detail with respect to system 300, and in particular device 301 and exemplary communications pathways between various components of the system. As shown, device 301 includes device platform 302 and device processor 303. Without limitation, device platform 302 may be any platform suitable for a mobile or other electronic device, as defined above. In some embodiments, device platform 302 is chosen from a cell phone platform, an electronic reader platform, an a handheld game console platform, a mobile internet device platform, a portable media player platform, a personal digital assistant platform, a smart phone platform, an ultra-mobile PC platform, a netbook platform, a notebook computer platform, and combinations thereof.

Device processor 303 may be general or application specific processor. In any case, device processor may be capable of executing software such as but not limited to operating system (OS) 304, applications (APPS) 305, and forecast initiation module 306. Such software may be stored in memory (not shown) that is local or accessible to device processor 303. Suitable memory types for this purpose include the same memory types specified for use with platform 200 above.

Forecast initiation module 306 may be implemented in the form of a computer readable medium having instructions stored thereon which when executed by device processor 303 cause device processor 303 to perform operations consistent with the present disclosure. For example, execution of forecast initiation module 306 may cause device processor 303 to provide a mechanism by which information relevant to a forecast request may be input. In this regard, forecast initiation module instructions when executed may cause device processor 303 to produce a user interface on a display (not shown) of device 301. Such user interface may for example be in the form of a standalone application, a web application (i.e., an application run within the context of a web browser), an electronic fillable form, combinations thereof, and the like.

In some embodiments, the user interface includes fillable fields, radio buttons, drop down menus, or other interface objects that allow an operator of device 301 to enter information relevant to a forecasting request. The user interface may therefore be configured to accept inputs regarding the item or items of interest (e.g., make, model, serial number, color, product code, etc.), a description of the item or a feature thereof, a time frame from the forecast, a desired geographic region, desired retailer(s), combinations thereof, and the like. Thus for example, forecast initiation module may send a forecast initiation request to discount forecasting module 204, either directly (not shown) or through network 102. The user interface produced on device 301 may also provide a mechanism through which user feedback may be received, as described later.

Discount forecasting module 204 may be configured to perform one or more forecasting operations consistent with the present disclosure in response to receiving a forecasting request. For example, discount forecasting module 204 may leverage communication resources (not shown) that are available to it to interface with historical marketplace source 103 and crowd source information database 104. Such communications may occur through a direct connection with the relevant database (not shown), through network 102, or through another mechanism (e.g., by proxy, also not shown). Discount forecasting module 204 may be further configured to calculate an initial probability of discount based on the obtained marketplace information, and adjust that initial probability as needed based on relevant crowd source information factors. Many of the specific operations (e.g., data gathering, initial prediction of discount, weighted prediction of discount prediction, etc.) performed by device 101 in response to the execution of discount forecasting module 204 are discussed above with respect to FIG. 1, and so are not discussed again here.

Discount forecasting module 204 may be implemented in the form of a computer readable medium having forecasting module instructions stored thereon which when executed by processor 201 cause forecasting device 101 to perform forecasting operations consistent with the present disclosure. In such instances, the forecasting module instructions when executed may cause forecasting device 201 to aggregate marketplace information and crowd source information in response to a forecasting request, and calculate one or more probabilities of discount as described herein.

User interface module 205 may be configured to enable forecasting device 101 to receive crowd source information, user feedback, forecasting request, and other information from one or more sources. For example, user interface module 205 may be configured to provide one or more websites, network interfaces, and the like through which such information be input and/or received. In some embodiments, user interface module may be further configured to route such information to an appropriate location. For example in instances where the user interface produced by the execution of user interface module received crowd source information, user interface module when executed may route such information to discount forecasting module 204 for consideration in calculating a probability of discount. Alternatively or additionally, user interface module 205 may route such information to crowd source information database 104, where it may be sourced for later reference. In further non-limiting embodiments, user interface module 205 may be configured to receive feedback from parties relying on the probabilities calculated by the systems and methods described herein, directly and/or from device 301. Thus for example, user interface module 205 may be configured to bi or uni-directionally communicate with other resources of device 101, as well as other devices.

Like discount forecasting module 204, user interface module 205 may be implemented as a computer readable medium having user interface module instructions stored thereon. The user interface module instructions when executed by a processor (e.g., processor 201) may cause device 101 to perform user interface operations consistent with the present disclosure. Such operations may include, for example, providing a mechanism through which device 101 may receive crowd source information, user feedback, and the like, either directly from a consumer or from another device.

As noted above, forecast initiation module 305 and/or user interface module 205 may also provide mechanism through which consumers (including parties acting on a forecasted probability of discount) may provide feedback into the system. Such feedback may include for example inputs as to whether the calculated probability was accurate, as well as other crowd source information gathered from that specific party. Like crowd source information in general, the systems and methods of the present disclosure may take such feedback into account and adjust the calculated probability of discount appropriately. The systems and methods may accomplish this adjustment for example by adding terms to the probability equations specified above to account for specific user feedback. In particular, the systems and methods may determine scores and assign weights to such feedback and incorporate such scores and weights into equation (3) above in the same manner as explained above for crowd source information factors pertaining to unadvertised, ad-hoc, or impromptu offers.

Thus for example, the systems and methods may receive feedback from a party acting on an initial probability of discount or a weighted probability of discount. The systems and methods may analyze such feedback for parameters relevant to the calculation of such probabilities. By way of example, feedback from one or more users may indicate that an item of interest was not on sale, despite the fact the systems described herein calculated a high probability of discount over the relevant time frame. In such instances, the systems and methods may utilize such factors to adjust the weighting and/or scoring of one or more of the marketplace information and crowd source information that were used to calculate the initial and weighted probabilities of discount. In this way, the systems and methods may further refine calculated probabilities of discount by adjusting the scoring and/or weighting of factors utilized in the calculation based on actual user feedback.

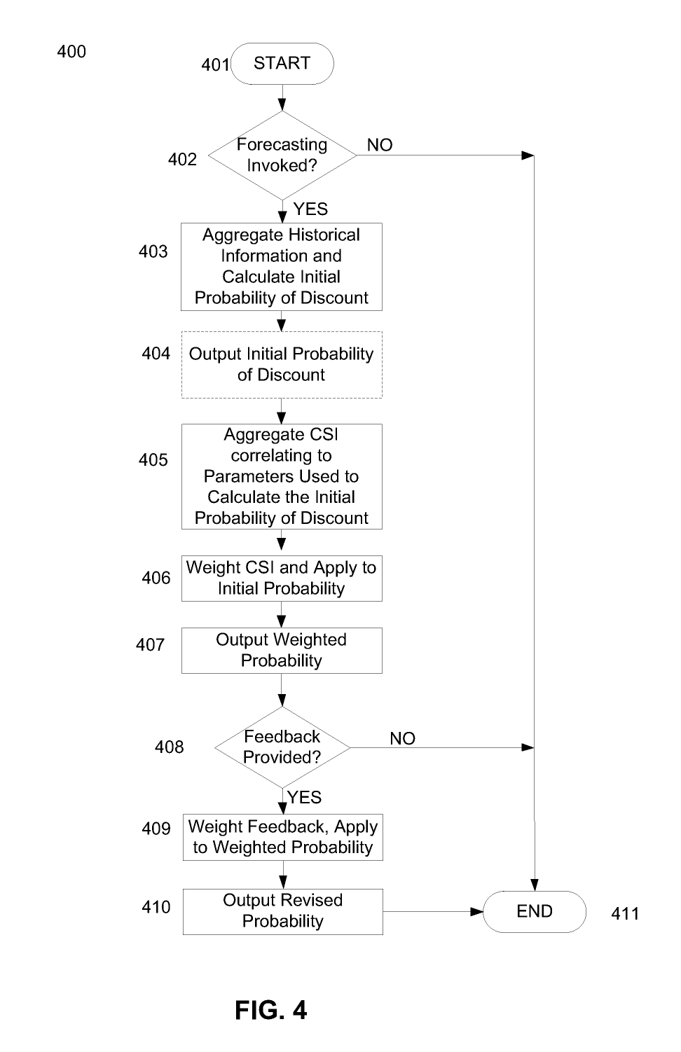

Another aspect of the present disclosure relates to methods for forecasting discounts using crowd source information. Reference is therefore made to FIG. 4, which depicts a flow diagram of an exemplary method consistent with the present disclosure. As shown, method 400 begins at block 401. At block 402, the method determined whether forecasting has been invoked. As noted previously, discount forecasting may be invoked/initiated by receipt of a forecasting request by a forecasting device, e.g., forecasting device 101 in FIG. 1. The forecasting request may be generated through direct inputs to the forecasting device, or by inputs made to another mobile or electronic device and conveyed to the forecasting device.

If forecasting has been invoked the method proceeds to block 403, wherein the forecasting system aggregates marketplace information relevant to the forecasting request, and calculates an initial probability of discount. In some embodiments, the method performs these operations in substantially the same manner as specified above for the forecasting systems illustrated in FIGS. 1-3B. At block 304, the method may optionally output the initial probability of discount.

The method may then proceed to blocks 405 and 406. At block 405, crowd source information (CSI) correlating to the historical marketplace factors used to calculate the initial probability of discount is/are aggregated. At block 406, the method weights the crowd source information (e.g., using market analytics, economic analyses, or a combination thereof). The method may then apply such weights to the corresponding marketplace information factors used in the calculation of the initial probability of discount, as discussed previously in connection with the systems of the present disclosure. In this way, the methods of the present disclosure may produce a weighted probability of discount. The method may then proceed to optional block 407, wherein the weighted probability of discount may be output.

At block 408, the method may determine whether feedback has been received from one or more users, and/or whether such feedback is to be applied to alter the weighted probability. If feedback has not been provided or will not be leveraged, the method ends. If feedback has been provided and will be leveraged, the method may proceed to block 409, wherein weights are assigned to the feedback in much the same manner as how weights are applied to crowd source information in block 406. The weights assigned to the feedback may then be applied to the weighted feedback generated in block 407, so as to produce a further revised probability of discount. At block 410, such revised probability of discount is output. The method ends at block 411.

As explained above, the systems and methods may calculate an initial and/or weighted probability that an item will be subject to a discount, based on marketplace information and crowd source information. Once such probabilities are determined, they may be output by the systems and methods of the present disclosure in an appropriate format. For example, the systems and methods described herein may output a signal representative of a calculated probability of discount. Such a signal may be in an appropriate format for interpretation and display, e.g., by a mobile or other electronic device. For example, the systems and methods may output a audio and/or visual signal that may be interpreted by a mobile or electronic device and output through the audio and/or visual resources available to such device (e.g., a speaker, a display, etc.). In this way, a consumer may inspect a calculated probability using such audio and/or visual resources.

According to one example there is provided a device for forecasting the probability of a discount. The device includes a discount forecasting module configured, in response to a forecasting request specifying an item and a second time frame, to aggregate marketplace information relevant to the forecasting request. The marketplace information includes one or more first factors. The discount forecasting module is further configured to assign respective weights (W) to and determine respective scores (H) for each of the first factors based on a correlation of each respective first factor to one or more offers on said item during a first time frame. The discount forecasting module is also configured to aggregate crowd source information relevant to the forecasting request, the crowd source information comprising one or more second factors. The discount forecasting module is also configured to determine respective values (C_{H}) for each of the second factors based on a correlation of each respective second factor to the existence or non-existence of the one or more offers. The discount forecasting module is also configured to calculate a weighted probability that the item will be subject to a discount in a second time frame using the respective weights (W), respective values (C_{H}), and respective scores (H). The discount forecasting module is also configured to output a signal representative of the weighted probability. In this example the second time frame is after the first time frame.

Another example of a device includes the foregoing components wherein the discount forecasting module is configured to calculate the weighted probability using the formula:

P_{R}=(Σ(Hₙ*C_{Hn})/Σ(Wₙ)*100

wherein P_{R} is a weighted probability of discount on the item during the second time frame, Hₙ are respective scores (H) determined by the forecasting module for each of the first factors, C_{Hn} are respective values (C_{H}) determined by the forecasting module for each respective second factor correlating to a respective first factor, and Wₙ are respective weights (W) assigned by the forecasting module to each of the first factors.

Another example of a device includes the foregoing components, wherein the first factors are chosen from discounted pricing on the item during the first time frame, a coupon on the item during the first time frame, a combination offer including the item during the first time frame, and combinations thereof.

Another example of a device includes the foregoing components, wherein the second factors include consumer input correlating to one or more of the first factors.

Another example of a device includes the foregoing components, wherein the second factors comprise information regarding the existence of an unadvertised discount on said item during said first time frame, an ad-hoc offer on said item during said first time frame, an impromptu offer on said item during said first time frame, accuracy of a previously calculated probability of discount on said item, and combinations thereof.

Another example of a device includes the foregoing components, wherein the discount forecasting module is further configured to assign respective weights (W_{U}) to and determine respective scores (U) for each of the second factors that comprise information regarding the existence of an unadvertised discount on the item during the first time frame, an ad-hoc offer on the item during the first time frame, an impromptu offer on the item during the first time frame, accuracy of a previously calculated probability of discount on said item, and combinations thereof.

Another example of a device includes the foregoing components, wherein the discount forecasting module is further configured to calculate the weighted probability using the following formula:

P_{R}=(Σ((Hₙ*C_{Hn})+(Uₙ))/Σ(W_{Hn})+(Σ(W_{Un}))*100%

wherein P_{R} is a weighted probability of discount on the item during second time frame, Hₙ are respective scores (H) determined by the forecasting module for each the first factors, C_{Hn} are the respective values (C_{H}) determined by said forecasting module to each respective second factor correlating to a respective first factor, Wₙ are the respective weights (W) assigned by the forecasting module to each of said first factors, and Uₙ are W_{Un} are the respective weights (W_{U}) assigned to and scores (U) determined by the forecasting module for each of said second factors comprising information regarding the existence of an unadvertised discount on said item during said first time frame, an ad-hoc offer on said item during said first time frame, an impromptu offer on said item during said first time frame, accuracy of a previously calculated probability of discount on said item, and combinations thereof.

According to another example there is provide a device for forecasting the probability of a discount. The device includes a processor and a memory having discount forecasting instructions stored therein. The discount forecasting instructions when executed by the processor cause the processor to, in response to receiving a forecasting request specifying an item and a second time frame, aggregate marketplace information relevant to the forecasting request, the marketplace information comprising one or more first factors. The discount forecasting instructions when executed further cause the processor to assign respective weights (W) to and determine respective scores (H) for each of the first factors based on a correlation of each respective first factor to one or more offers on the item during a first time frame. The discount forecasting instructions when executed further cause the processor to aggregate crowd source information relevant to the forecasting request, the crowd source information including one or more second factors. The discount forecasting instructions when executed may further cause the processor to determine respective values (C_{H}) for each of the second factors based on a correlation of each respective second factor to the existence or non-existence of one or more offers. The discount forecasting instructions when executed may further cause the processor to calculate a weighted probability that the item will be subject to a discount in a second time frame using the respective weights (W), respective values (C_{H}), and respective scores (H). Finally, the discount forecasting instructions when executed may cause the processor to output a signal representative of said weighted probability. In this example, the second time frame is after said first time frame.

Another example of a device includes the foregoing components, wherein the discount forecasting instructions when executed further cause the processor to calculate the weighted probability using the following formula:

P_{R}=(Σ(Hₙ*C_{Hn})/Σ(Wₙ)*100

wherein P_{R} is a weighted probability of discount on the item during said second time frame, Hₙ are respective scores (H) determined by the forecasting module for each of the first factors, C_{Hn} are respective values (C_{H}) determined by the forecasting module for each respective second factor correlating to a respective first factor, and Wₙ are respective weights (W) assigned by the forecasting module to each of the first factors.

Another example of a device includes the foregoing components, wherein the first factors are chosen from discounted pricing on the item during said first time frame, a coupon on the item during the first time frame, a combination offer including the item during the first time frame, and combinations thereof.

Another example of a device includes the foregoing components, wherein the second factors include consumer input correlating to one or more of the first factors

Another example of a device includes the foregoing components, wherein the second factors comprise information regarding the existence of an unadvertised discount on the item during the first time frame, an ad-hoc offer on the item during the first time frame, an impromptu offer on the item during the first time frame, accuracy of a previously calculated probability of discount on said item, and combinations thereof.

Another example of a device includes the foregoing components, wherein the discount forecasting instructions when executed further cause the processor to assign respective weights (W_{U}) to and determine respective scores (U) for each of the second factors that include information regarding the existence of an unadvertised discount on the item during the first time frame, an ad-hoc offer on the item during the first time frame, an impromptu offer on the item during the first time frame, accuracy of a previously calculated probability of discount on said item, and combinations thereof.

Another example of a device includes the foregoing components, wherein the discount forecasting instructions when executed further cause the processor to calculate the weighted probability using the following formula:

P_{R}=(Σ((Hₙ*C_{Hn})+(Uₙ))/Σ(W_{Hn})+(Σ(W_{Un}))*100%

wherein P_{R} is a weighted probability of discount on the item during the second time frame, Hₙ are respective scores (H) determined by the forecasting module for each the first factors, C_{Hn} are the respective values (C_{H}) assigned by the forecasting module to each respective second factor correlating to a respective first factor, Wₙ are the respective weights (W) assigned by the forecasting module to each of the first factors, and Uₙ are W_{Un} are the respective weights (W_{U}) assigned to and scores (U) determined by the forecasting module for each of the second factors comprising information regarding the existence of an unadvertised discount on the item during the first time frame, an ad-hoc offer on the item during the first time frame, an impromptu offer on the item during the first time frame, accuracy of a previously calculated probability of discount on said item, and combinations thereof

In another example there is provided a first device for initiating a discount forecast. The first device includes a processor and a memory having forecast initiation instructions stored therein. The forecast initiation instructions when executed by the processor cause the first device to communicate a forecast request specifying a plurality of parameters to a second device. The plurality of parameters include an identify of an item and a second time frame. In this example, the forecast request is configured to cause the second device to aggregate marketplace information relevant to the forecasting request, the marketplace information comprising one or more first factors.

The forecast request is further configured to cause the second device to assign respective weights (W) to and determine respective scores (H) for each of the first factors based on a correlation of each respective first factor to one or more offers on the item during a first time frame. In addition, the forecast request is configured to cause the second device to aggregate crowd source information relevant to said forecasting request, the crowd source information including one or more second factors. The forecast request is also configured to cause the second device to determine respective values (C_{H}) for each of the second factors based on a correlation of each respective second factor to the existence or non-existence of the one or more offers. The forecast request is further configured to cause the second device to calculate a weighted probability that the item will be subject to a discount in a second time frame using the respective weights (W), respective values (C_{H}), and respective scores (H). Finally, the forecast request is further configured to cause the second device to output a signal representative of the weighted probability. In such example, the second time frame is after the first time frame.

In another example the first device includes the foregoing components and the forecasting request is configured to cause the second device to calculate the weighted probability using the following formula:

P_{R}=(Σ(Hₙ*C_{Hn})/Σ(Wₙ)*100

wherein P_{R} is a weighted probability of discount on the item during the second time frame, Hₙ are respective scores (H) determined by the forecasting module for each of the first factors, C_{Hn} are respective values (C_{H}) determined by the forecasting module for each respective second factor correlating to a respective first factor, and Wₙ are respective weights (W) assigned by the forecasting module to each of the first factors.

In another example the first device includes the foregoing components wherein the first factors are chosen from discounted pricing on the item during said first time frame, a coupon on the item during the first time frame, a combination offer including the item during the first time frame, and combinations thereof

In another example the first device includes the foregoing components wherein the second factors comprise consumer input correlating to one or more of the first factors.

In another example the first device includes the foregoing components wherein the second factors include information regarding the existence of an unadvertised discount on the item during the first time frame, an ad-hoc offer on the item during the first time frame, an impromptu offer on the item during the first time frame, accuracy of a previously calculated probability of discount on said item, and combinations thereof.

In another example the first device includes the foregoing components, and the forecast request is further configured to cause the second device to assign respective weights (W_{U}) to and determine respective scores (U) for each of the second factors that comprise information regarding the existence of an unadvertised discount on the item during said first time frame, an ad-hoc offer on the item during the first time frame, and impromptu offer on the item during the first time frame, accuracy of a previously calculated probability of discount on said item, and combinations thereof

In another example the first device includes the foregoing components, wherein the forecast request is further configures to cause the second device to calculate said weighted probability using the following formula:

P_{R}=(Σ((Hₙ*C_{Hn})+(Uₙ))/Σ(W_{Hn})+(Σ(W_{Un}))*100%

wherein P_{R} is a weighted probability of discount on the item during said second time frame, Hₙ are respective scores (H) determined by the second device for each said first factors, C_{Hn} are the respective values (C_{H}) assigned by the second device to each respective second factor correlating to a respective first factor, Wₙ are the respective weights (W) assigned by the second device to each of said first factors, and Uₙ are W_{Un} are the respective weights (W_{U}) assigned to and scores (U) determined by the second device for each of the second factors that include information regarding the existence of an unadvertised discount on the item during the first time frame, an ad-hoc offer on the item during the first time frame, an impromptu offer on the item during the first time frame, accuracy of a previously calculated probability of discount on said item, and combinations thereof

According to another example there is provided a method of forecasting a discount on an item. The method includes, in response to a forecasting request specifying an identity of the item and a second time frame, aggregating with a mobile or other electronic device marketplace information relevant to the forecasting request, the marketplace information comprising one or more first factors. The method further includes assigning respective weights (W) to and determining respective scores (H) for each of the first factors based on a correlation of each respective first factor to one or more offers on the item during a first time frame. The method further includes aggregating crowd source information relevant to the forecasting request, the crowd source information including one or more second factors. The method further includes determining respective values (C_{H}) for each of the second factors based on a correlation of each respective second factor to the existence or non-existence of the aforementioned one or more offers. The method further includes calculating a weighted probability that the item will be subject to a discount in a second time frame using the respective weights (W), respective values (C_{H}), and respective scores (H). Finally, the method includes outputting a signal representative of the weighted probability. In this example, the second time frame is after the first time frame.

Another example of a method includes the aforementioned elements, wherein the weighted probability is calculated using the following formula:

P_{R}=(Σ(Hₙ*C_{Hn})/Σ(Wₙ)*100

wherein P_{R} is a weighted probability of discount on the item during the second time frame, Hₙ are respective scores (H) determined for each of the first factors, C_{Hn} are respective values (C_{H}) determined for each respective second factor correlating to a respective first factor, and Wₙ are respective weights (W) assigned to each of the first factors.

Another example of a method includes the foregoing components, wherein the first factors are chosen from discounted pricing on the item during the first time frame, a coupon on the item during the first time frame, a combination offer including the item during the first time frame, and combinations thereof.

Another example of a method includes the foregoing components, wherein the second factors include consumer input correlating to one or more of said first factors.

Another example of a method includes the foregoing components, wherein the second factors include information regarding the existence of an unadvertised discount on the item during the first time frame, an ad-hoc offer on the item during the first time frame, and impromptu offer on the item during the first time frame, accuracy of a previously calculated probability of discount on said item, and combinations thereof.

Another example of a method includes the foregoing components, and further includes assigning respective weights (W_{U}) to and determining respective scores (U) for each of the second factors that comprise information regarding the existence of an unadvertised discount on the item during the first time frame, an ad-hoc offer on the item during said first time frame, and impromptu offer on the item during said first time frame, accuracy of a previously calculated probability of discount on said item, and combinations thereof.

Another example of a method includes the foregoing components, wherein the weighted probability is calculated using the following formula:

P_{R}=(Σ((Hₙ*C_{Hn})+(Uₙ))/Σ(W_{Hn})+(Σ(W_{Un}))*100%

wherein P_{R} is a weighted probability of discount on said item during said second time frame, Hₙ are respective scores (H) determined for each said first factors, C_{Hn} are the respective values (C_{H}) assigned to each respective second factor correlating to a respective first factor, Wₙ are the respective weights (W) assigned to each of said first factors, and Uₙ are W_{Un} are the respective weights (W_{U}) assigned to and scores (U) determined for each of said second factors including information regarding the existence of an unadvertised discount on the item during the first time frame, an ad-hoc offer on the item during the first time frame, an impromptu offer on the item during the first time frame, accuracy of a previously calculated probability of discount on said item, and combinations thereof.

According to another example there is provided a computer readable medium. The computer readable medium includes discount forecasting instructions stored therein. The discount forecasting instructions when executed by a processor cause the processor to, in response to receiving a forecasting request specifying an item and a second time frame, aggregate marketplace information relevant to the forecasting request, the marketplace information comprising one or more first factors. The discount forecasting instructions when executed further cause the processor to assign respective weights (W) to and determine respective scores (H) for each of the first factors based on a correlation of each respective first factor to one or more offers on the item during a first time frame. The discount forecasting instructions when executed further cause the processor to aggregate crowd source information relevant to the forecasting request, the crowd source information including one or more second factors. The discount forecasting instructions when executed may further cause the processor to determine respective values (C_{H}) for each of the second factors based on a correlation of each respective second factor to the existence or non-existence of one or more offers. The discount forecasting instructions when executed may further cause the processor to calculate a weighted probability that the item will be subject to a discount in a second time frame using the respective weights (W), respective values (C_{H}), and respective scores (H). Finally, the discount forecasting instructions when executed may cause the processor to output a signal representative of said weighted probability. In this example, the second time frame is after said first time frame.

Another example of a computer readable includes the foregoing components, wherein the discount forecasting instructions when executed further cause the processor to calculate the weighted probability using the following formula:

P_{R}=(Σ(Hₙ*C_{Hn})/Σ(Wₙ)*100

wherein P_{R} is a weighted probability of discount on the item during said second time frame, Hₙ are respective scores (H) determined by the forecasting module for each of the first factors, C_{Hn} are respective values (C_{H}) determined by the forecasting module for each respective second factor correlating to a respective first factor, and Wₙ are respective weights (W) assigned by the forecasting module to each of the first factors.

Another example of a computer readable includes the foregoing components, wherein the first factors are chosen from discounted pricing on the item during said first time frame, a coupon on the item during the first time frame, a combination offer including the item during the first time frame, and combinations thereof.

Another example of a computer readable includes the foregoing components, wherein the second factors include consumer input correlating to one or more of the first factors

Another example of a computer readable includes the foregoing components, wherein the second factors comprise information regarding the existence of an unadvertised discount on the item during the first time frame, an ad-hoc offer on the item during the first time frame, an impromptu offer on the item during the first time frame, accuracy of a previously calculated probability of discount on said item, and combinations thereof.

Another example of a computer readable includes the foregoing components, wherein the discount forecasting instructions when executed further cause the processor to assign respective weights (W_{U}) to and determine respective scores (U) for each of the second factors that include information regarding the existence of an unadvertised discount on the item during the first time frame, an ad-hoc offer on the item during the first time frame, an impromptu offer on the item during the first time frame, accuracy of a previously calculated probability of discount on said item, and combinations thereof.

Another example of a computer readable includes the foregoing components, wherein the discount forecasting instructions when executed further cause the processor to calculate the weighted probability using the following formula:

P_{R}=(Σ((Hₙ*C_{Hn})+(Uₙ))/Σ(W_{Hn})+(Σ(W_{Un}))*100%

wherein P_{R} is a weighted probability of discount on the item during the second time frame, Hₙ are respective scores (H) determined by the forecasting module for each the first factors, C_{Hn} are the respective values (C_{H}) assigned by the forecasting module to each respective second factor correlating to a respective first factor, Wₙ are the respective weights (W) assigned by the forecasting module to each of the first factors, and Uₙ are W_{Un} are the respective weights (W_{U}) assigned to and scores (U) determined by the forecasting module for each of the second factors comprising information regarding the existence of an unadvertised discount on the item during the first time frame, an ad-hoc offer on the item during the first time frame, an impromptu offer on the item during the first time frame, accuracy of a previously calculated probability of discount on said item, and combinations thereof

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

Other embodiments of the present disclosure will be apparent to those skilled in the art from consideration of the specification and practice of the inventions disclosed herein. It is intended that the specification be considered as exemplary only, with a true scope and spirit of the invention being indicated by the following claims.

1-35. (canceled)

36. A device to generate a forecast, comprising:
communications circuitry to interact via wired or wireless electronic communication;
physical programmable circuitry to execute program code to transform the physical programmable circuitry into circuitry configured to perform specialized operations; and
discount forecasting circuitry resulting from the physical programmable circuitry executing the program code, wherein the discount forecasting circuitry is to:
receive a forecast request via the communications circuitry, the forecast request identifying at least one item for purchase;
cause the communications circuitry to interact with at least one marketplace information source to aggregate marketplace information regarding the item;
cause the communication circuitry to interact with at least one crowd source information source to aggregate crowd source information regarding the item;
execute one or more forecasting operations; and
generate a probability of discount relevant to the at least one item.

37. The device of claim 36, wherein the forecast request is received from another device comprising at least processing circuitry to perform operations associated with a forecast initiation circuitry to cause the other device to provide a mechanism by which information relevant to the forecast request may be input by a user of the other device.

38. The device of claim 37, wherein the forecast initiation circuitry is further to cause the other device to provide a mechanism by which crowd source information is gathered from the user.

39. The device of claim 38, wherein the crowd source information comprises user feedback.

40. The device of claim 36, wherein the marketplace information comprises at least historical pricing information for the item.

41. The device of claim 36, wherein the at least one marketplace information source comprises at least one of public sources including at least one of advertising and reseller websites, and private sources including at least one of market research firms and market research databases.

42. The device of claim 36, wherein in interacting with the at least one marketplace information source the processing circuitry is to implement search programs to search the marketplace information on a network to which the device is coupled and on any resources connected to the network.

43. The device of claim 36, wherein the crowd source information comprises user experiences regarding at least one of shopping for, researching or attempting to purchase the item.

44. The device of claim 36, wherein in executing one or more forecasting operations the processing circuitry is to:
determine marketplace information factors based on the marketplace information; and
determine crowd source information factors based on the crowd sourced information.

45. The device of claim 44, wherein the processing circuitry is further to:
assign at least one of a weight to each marketplace information factor;
determine a score for each marketplace information factor;
determine an initial probability of discount based on the weights and scores of the marketplace information factors;
assign a weight to each crowd source information factor;
adjust at least one marketplace information factor score based on at least one relevant weighted crowd source information factor; and
determine the probability of discount based at least on the adjusted marketplace information factor scores.

46. The device of claim 36, wherein the processing circuitry is to cause the communications circuitry to transmit a signal comprising at least the probability of discount, the signal comprising a format for interpretation and display on a device that receives the signal.

47. A method for generating a forecast, comprising:
receiving a forecast request via communications circuitry in a device, the forecast request identifying at least one item for purchase;
causing the communications circuitry to interact with at least one marketplace information source to aggregate marketplace information regarding the item;
causing the communication circuitry to interact with at least one crowd source information source to aggregate crowd source information regarding the item;
causing processing circuitry also in the device to execute one or more forecasting operations; and
causing the processing circuitry to generate a probability of discount relevant to the at least one item.

48. The method of claim 47, wherein the at least one marketplace information source comprises at least one of public sources including at least one of advertising and reseller websites, and private sources including at least one of market research firms and market research databases.

49. The method of claim 47, wherein interacting with the at least one marketplace information source comprises causing the processing circuitry to implement search programs to search the marketplace information on a network to which the device is coupled and on any resources connected to the network.

50. The method of claim 47, wherein the crowd source information comprises user experiences regarding at least one of shopping for, researching or attempting to purchase the item.

51. The method of claim 47, wherein executing one or more forecasting operations comprises:
causing the processing circuitry to determine marketplace information factors based on the marketplace information; and
causing the processing circuitry to determine crowd source information factors based on the crowd sourced information.

52. The method of claim 51, further comprising:
causing the processing circuitry to assign at least one of a weight to each marketplace information factor;
causing the processing circuitry to determine a score for each marketplace information factor;
causing the processing circuitry to determine an initial probability of discount based on the weights and scores of the marketplace information factors;
causing the processing circuitry to assign a weight to each crowd source information factor;
causing the processing circuitry to adjust at least one marketplace information factor score based on at least one relevant weighted crowd source information factor; and
causing the processing circuitry to determine the probability of discount based at least on the adjusted marketplace information factor scores.

53. The method of claim 47, further comprising:
causing the communications circuitry to transmit a signal comprising at least the probability of discount, the signal comprising a format for interpretation and display on a device that receives the signal.

54. At least one computer-readable storage medium having stored thereon, individually or in combination, instructions for generating a forecast that, when executed by one or more processors, cause the one or more processors to:
receive a forecast request via communications circuitry in a device, the forecast request identifying at least one item for purchase;
cause the communications circuitry to interact with at least one marketplace information source to aggregate marketplace information regarding the item;
cause the communication circuitry to interact with at least one crowd source information source to aggregate crowd source information regarding the item;
execute one or more forecasting operations; and
generate a probability of discount relevant to the at least one item.

55. The storage medium of claim 54, wherein the at least one marketplace information source comprises at least one of public sources including at least one of advertising and reseller websites, and private sources including at least one of market research firms and market research databases.

56. The storage medium claim 54, wherein the instructions to interact with the at least one marketplace information source comprise instructions to implement search programs to search the marketplace information on a network to which the device is coupled and on any resources connected to the network.

57. The storage medium of claim 54, wherein the crowd source information comprises user experiences regarding at least one of shopping for, researching or attempting to purchase the item.

58. The storage medium of claim 54, wherein the instructions to execute one or more forecasting operations comprises instructions to:
determine marketplace information factors based on the marketplace information; and
determine crowd source information factors based on the crowd sourced information.

59. The storage medium of claim 58, further comprising instructions that, when executed by one or more processors, cause the one or more processors to:
assign at least one of a weight to each marketplace information factor;
determine a score for each marketplace information factor;
determine an initial probability of discount based on the weights and scores of the marketplace information factors;
assign a weight to each crowd source information factor;
adjust at least one marketplace information factor score based on at least one relevant weighted crowd source information factor; and
determine the probability of discount based at least on the adjusted marketplace information factor scores.

60. The storage medium of claim 54, further comprising instructions that, when executed by one or more processors, cause the one or more processors to:
transmit a signal comprising at least the probability of discount, the signal comprising a format for interpretation and display on a device that receives the signal.
